(19) United States
(12) Patent Application Publication
(10) Pub. No.: US 2003/0200623 A1
(43) Pub. Date: Oct. 30, 2003

(54) Two stage compressive spring operated door check hinge

(76) Inventor: Wen-Yi Hung, Yung-Ho City (TW)

Correspondence Address: BRUCE H. TROXELL, SUITE 1404, 5205 LEESBURG PIKE, FALLS CHURCH, VA, 22041, US

(21) Appl. No.: 10/114,480

(22) Filed: Apr. 3, 2002

(51) Int. Cl. E05F 3/20

(52) U.S. Cl. 16/50

(57) ABSTRACT

Disclosed herein is a two stage compressive spring operated door check hinge. It has two springs of different length equipped along an outer tube to serve two stage restoring force. A unique design of collaborated function of the set billets and the corresponding containment holes enable the door to pause at a desired position. An adjustable nut is provided to adjust the elastic force of two springs such that the operation of the door can be carried out smoothly and silently without installing an awkward articulated door check arm.

### BACKGROUND OF THE INVENTION

1. Field of the Invention

The present invention relates to a two stage compressive spring operated door check hinge, and more particularly, to a door check hinge equipped with an inner and an outer compressive springs, one, or a plurality of set billets and their containment holes formed at the bottom of the door hinge, so as to operate the door to move in stages and be positioned thereat.

2. Description of the Prior Art

FIGS. 1(A) and 1(B) respectively show schematic views of a conventional automatic restoring door check hinge and an articulated door check arm operating in collaboration with the automatic restoring door check hinge. As shown in FIG. 1(A), an automatic restoring door check hinge 700 is provided with two wing plates 710 in two sides. Each of the two door wings 710 has a sleeve whose upper and lower portions are separated by a spacer. The two wing plates 710 commonly own a hinge pin 720 wound by a compressive spring 730 each its terminal is secured to respective wing plate 710 such that both wing plates 710 are tamable with respect to the hinge pin 720 thereby opening/closing the door.

To shut an open door unforcibly and silently, an articulated door check 800 as shown in FIG. 1B is conventionally equipped on the upper portion of the door and the door frame so as to automatically close the door silently and slowly with the aid of a restoring spring force. But the open door is usually limited to not wider than an open angle of 80:

However, a conventional compressive spring door hinge associated with the articulated door check arm for automatic door close operation described above has the following shortcomings:

1. The outwardly equipped compressive spring will yield and loose its restoring elasticity after being in use for long time.

2. Replacement for existing spring is impossible, even it is not easy to adjust its elastic force.

3. An oil pressure operated door check fails due to oil leakage after repeated operation, moreover, awkward construction of two articulating aims for the door check spoils outerlook of a door.

4. The door check with this structure is fragile and not easy for regular maintenance as well.

In view of above facts, a new check which can palliate the disadvantages of conventional products is definitely necessary. The present inventor has delved into this matter with long time effort and come to realization of the present invention.

### SUMMARY OF THE INVENTION

It is an object of the present invention to provide a two stage compressive spring operated door check hinge which can stably turn for opening and closing the door in two stages silently by compressive spring force.

It is another object of the present invention to provide a two stage compressive spring operated door check hinge which is simply constructed without an articulated arm so as to facilitate assembling, installation and regular maintenance.

To achieve the above mentioned objects, the door check hinge according to the present invention carries our smooth turning by means of sliding movement of screw rails in spiral grooves. And, two stage movement of the door is carried out by a two stage restoring force produced by two compressing springs associated with set billets and their containment holes formed at the bottom portion of the door check hinge, and enable the door to pause at a prescribed open angle (for example 80°)

The above objects and other advantages of the present invention will become more apparent by describing in detail the preferred embodiment of the present invention with reference to the attached drawings.

### BRIEF DESCRIPTION OF THE DRAWINGS

FIG. 1A is a schematic view of a conventional automatic restoring door check hinge.

FIG. 1B is a schematic view of an articulated door check arm operating in collaboration with the automatic door check hinge of FIG. 1A.

FIG. 2 is an exploded view of the two stage compressive spring operated door check hinge according to the present invention.

FIG. 3 is a cross sectional view of the two stage compressive spring operated door check hinge of the present invention when the door is closed.

FIG. 3A is a partial schematic view of the slide blocks and the compressive springs shown in FIG. 3.

FIG. 4 is a cross sectional view showing the inner spring is in compressed state when the door hinge is open in an embodiment of the present invention.

FIG. 4A is a partial schematic view showing the state of the springs and the slide blocks in FIG. 4.

FIG. 5 is a cross sectional view showing that both spring elements are simultaneously compressed to actuate the set billets when the door hinge is open a certain angle in an embodiment of the present invention.

FIG. 5A is a partial schematic view showing the state of the springs and the slide blocks in FIG. 5.

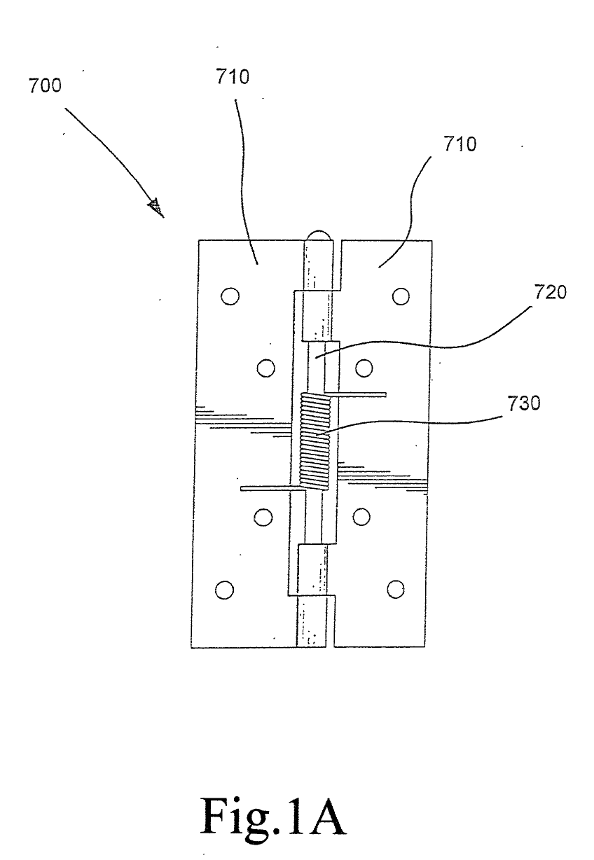

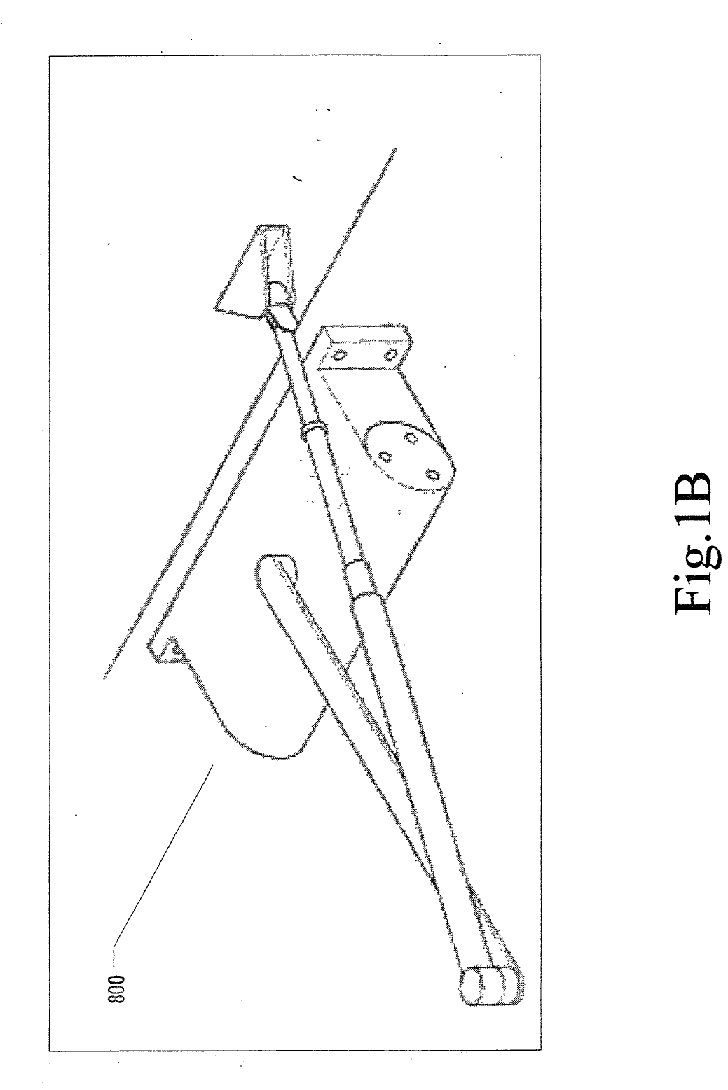

### DETAILED DESCRIPTION OF THE PREFERRED EMBODIMENT

The operation of the conventional articulated door check arm operating in collaboration with the automatic door check hinge has been described above and will not be repeated herein.

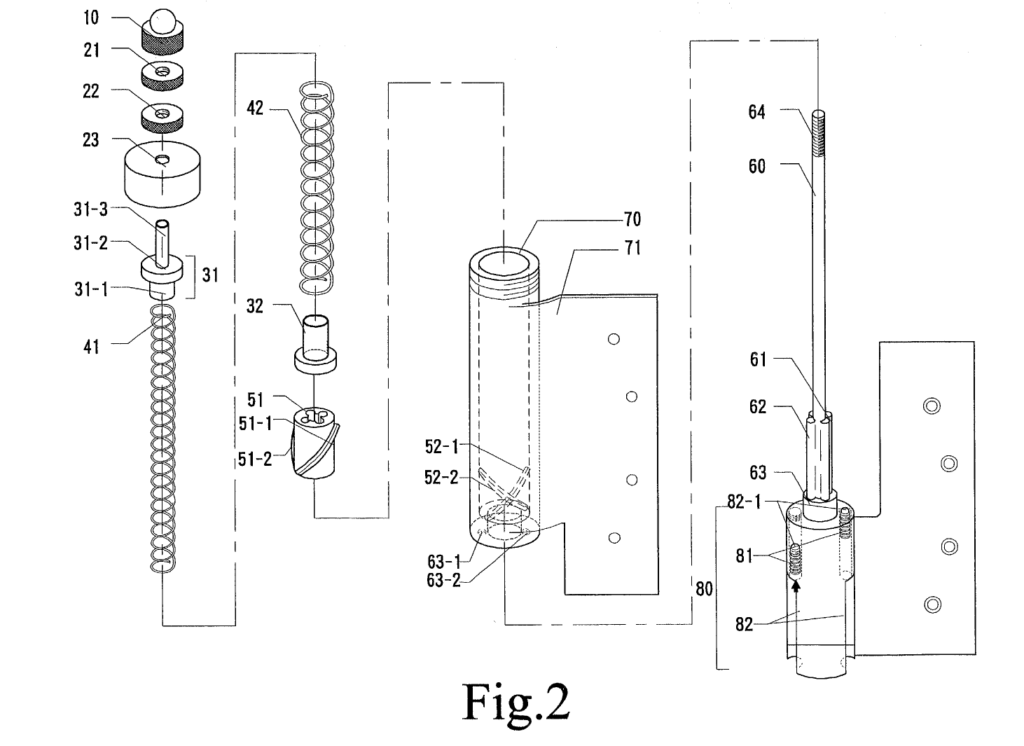

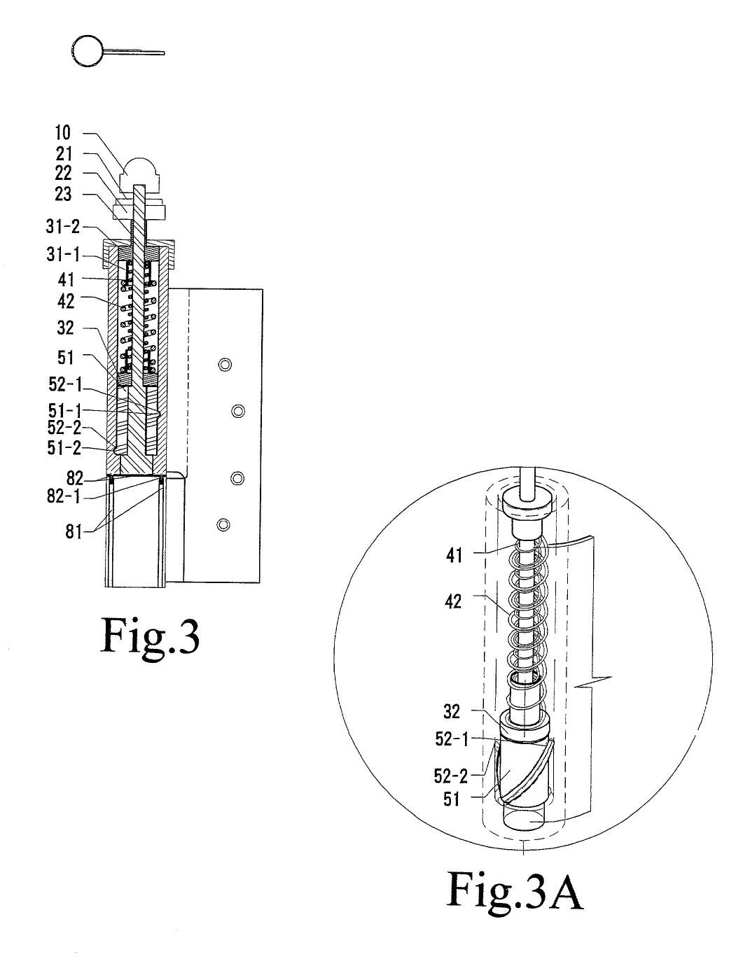

Referring to FIGS. 2 and 3 simultaneously, the two stage compressive spring operated door check hinge of the present invention comprises: a base tube 80, an outer tube 70, a cylindrical slide block 51, a pair of upper and lower spacer block 31 and 32, the upper lid 23, and a fixing nut 21 associated with an adjustable nut 22 and a cap 10.

The base tube 80 has a stationary wing plate at its side thereof for securing to the door body. A pad 63 of smaller diameter is formed at the upper end of tube 80 thereof. From the center of the pad block 63 there is a center pin 60 of even smaller diameter extending upwardly. A pair of symmetrically disposed guide tracks 61, 62 are formed at both sides of the lower end of the center pin 60. Several vertical via holes 81 are formed approximately equally apart of each other along the longitudinal direction through the body of the base tube 80 outside of the pad block 63 for screw engaging with respective spring elements 82 by screw threads provided at the top portion of the via holes 81 and on the spring elements 82. A set billet 82-1 is provided for each spring element 82 on its top end thereof and is movable up and down in the via hole 81 by spring force.

The outer tube 70 has a butterfly wing 71 formed at one side thereof for securing to the door frame. The outer tube 70 has a diameter able to let it sleeve over and enclose the base tube 80 up to the upper end of the base tube 80. A pair of symmetrical spiral grooves 52-1, 52-2 is formed in its lower inner tubular cavity. Equal number spherical containment holes 63-1, 63-2 . . . aimed at the corresponding positions of the set billets 82-1 are formed on the bottom of the tube body for permitting the set billets 82-1 to enter after being flicked up by the spring element 82.

The cylindrical slide block 51 having several through holes formed at its center portion is inserted into the center pin 60 and the guide tracks 61, 62 of the base tube 80. A pair of symmetrical spiral rails 51-1, 51-2 is formed on its outer wall surface such that it is able to relatively slide with the outer tube 70 by mating the spiral rails 51-1, 51-2 with the spiral grooves 52-1, 52-2 after being conjoined to the outer tube 70.

The lower spacer block 32 is configured into a protruded tube body for mounting on the top end of the cylindrical slide block 51 after being sleeved into the center pin 60. The inner part thereof is for equipping an inner spring 41, while the outer part thereof is for equipping an outer spring 42.

The upper spacer block 31 is a downwardly protruded tube body mounted on top of the lower spacer block 32. It consists of an inner tube 31-1 and a pad block 31-2. The inner spring 41 is equipped in the inner tube 31-1, while the outer spring 42 is in contact with the pad block 31-2, and the two springs 41 and 42 are isolated by the inner tube 31-1. The inner spring 41 is longer than the outer spring 42.

The upper lid 23 has a hole at its center for letting through the center pin 60 and covers the top of the outer tube 70.

The fixing nut 21, the adjustable nut 22, and the cap 10 are screw engaged with the center pin 60 by the screw threads 64 provided on the center pin 60. The height of the pad block 31-2 can be adjusted by the adjustable nut 22. Also the restoring force of the springs 41 and 42 can be controlled by adjusting the length of the two springs 41 and 42 through tightening or loosening the adjustable nut 22 so as to meet the requirements of various situations.

As shown in FIG. 3, before the hinge is closed or opened to a prescribed angle, the set billet 82-1 on the spring element 82 in the vertical via hole 81 is under the compressed state. As soon as the hinge has reached an open angle of (for example 90°), the spring element 82 flicks the set billet 82-1 into the containment hole 63-1 (63-2) thereby halting movement of the butterfly hinge 71.

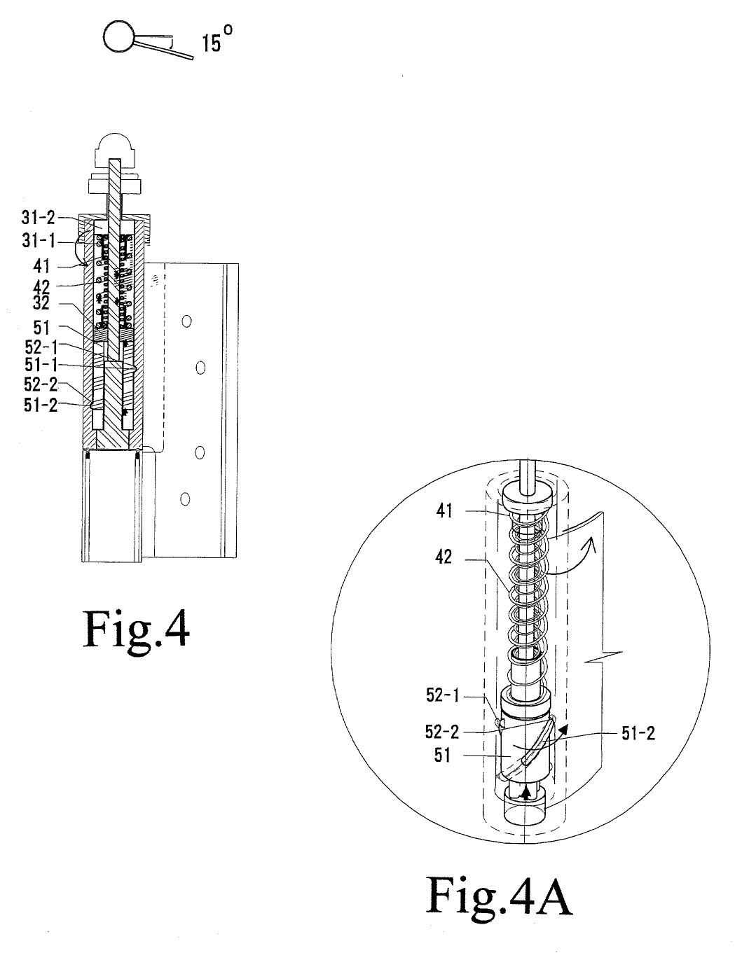

Referring to FIGS. 4 and 4A, in an embodiment of the present invention, when an external force is applied to the hinge for turning preferably within the range of 15°, the outer tube 70 follows to move and causes a relative slide motion between the spiral slide grooves 52-1, 52-2 on the inner wall of the outer tube 70 and the spiral rails 51-1, 51-2 of the cylindrical slide block 51 such that the slide block 51 ascends along the slide tracks 61, 62 to compress the inner spring 41 causing it to produce a restoring force.

After the turning angle of the hinge has exceeded the preferable angle 15°, the slide block 51 begins to compress the outer spring 42 such that the outer spring 42 produces a restoring force.

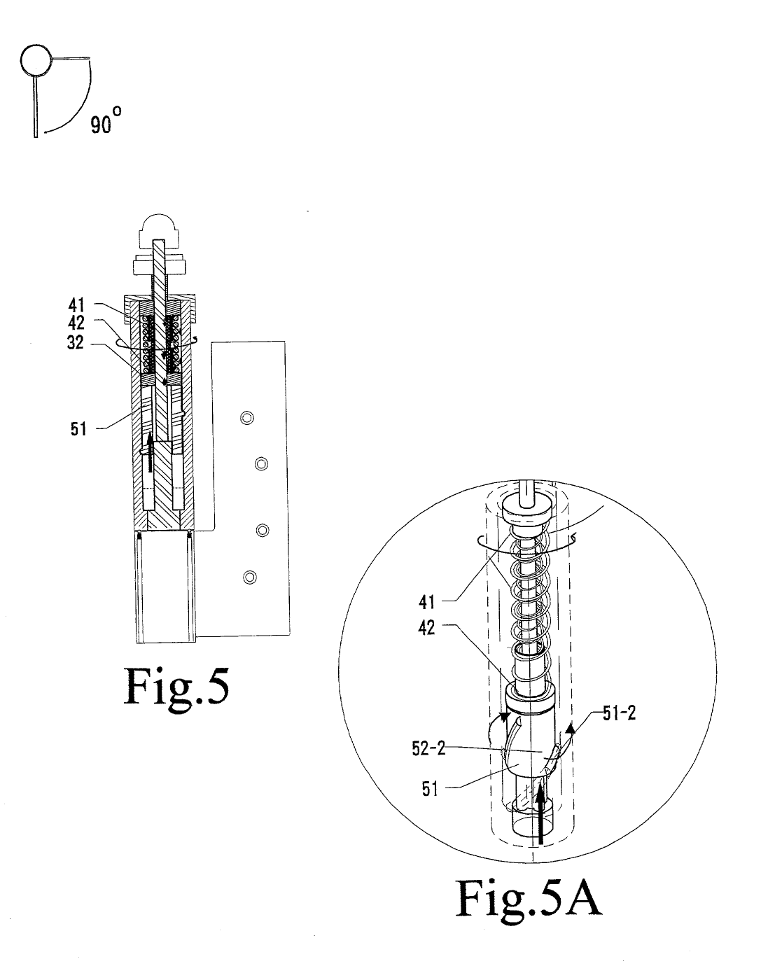

Referring to FIGS. 5 and 5A, when the turning angle has reached an angle preferably 90°, the vertical via holes 81 are aligned to the containment holes 63-1, 63-2 . . . , and the spring elements 82 are loosened to flick the set billets 82-1 into the containment holes 63-1, 63-2 thereby halting the movement of the hinge.

It is understood form the above description that the two stage compressive spring operated door check hinge has several noteworthy advantages, in particular:

(1) The different length of the two springs 41 and 42 can be properly adjusted with the adjustable nut 22 before use so as to avoid door noise.

(2) Relative slide notion between the spiral slide grooves 52-1, 52-2 of the outer tube 70 and the spiral rails 51-1, 52-2 of the slide block 51 contributes to smooth and stable door operation.

(3) For adjustment to obtain a proper door operation speed and applicable force, firstly the fixing nut 22 may be loosened to separate its lower end from the top end of the adjustable nut 22, by turning the adjustable nut 22 to move the upper spacer block 31 which in turn presses or releases the spring 41 and 42, after the desired adjustment is attained, turning tightly the fixing nut 21 to make its lower end forcibly in contact with the upper end of the adjustable nut 22, by so the operation noise can be refuced.

(4) Replacement of inner and outer springs 41 and 42 are so easy that the existing spring can be taken out only by detaching the fixing nut 21, adjustable nut 22, and the upper lid 23.

(5) the two stage restoring force for the door hinge is obtained by the two springs 41 and 42 equipped along the outer tube 70. Besides, unique design of collaborated action of the set billets and the containment holes enables the door to pause at a desired position.

Only a preferred embodiment of the present invention is shown and desired herein. It is to be understood that the present invention is capable of changes or modification or combination within the scope of inventive concept as expressed herein.

What is claimed is:

1. A two stage compressive spring operated door heck hinge comprising a base tube having a stationary wing plate at its side thereof for securing to the door body, a pad block of smaller diameter being formed at the upper end of said tube thereof, a center pin of even smaller diameter being extended upwardly form the center of said pad lock, a pair of symmetrically disposed guide tracks being formed at both sides of the lower end of said center pin;
an outer tube having a butterfly wing formed ay one side thereof for securing to a door frame, said outer tube having a diameter able to let it sleeve and enclose said base tube up to the upper end of said base tube, a pair of symmetrical spiral grooves being formed in its inner tube cavity;
a cylindrical slide block having several through holes formed at its center portion thereof being inserted into said center pin and said guide tracks of said base tube, a pair of symmetrical spiral rails being formed on its outer wall surface such that it being able to relatively slide with said outer tube by mating said spiral rails with said spiral grooves after it being conjunction to said outer tube;
an upper spacer block and a lower spacer block being provided on the top end of said cylindrical slide block, the inner parts of said spacer blocks being for equipping an inner spring, while the outer parts thereof being for equipping an outer spring; and
a fixing nut and an adjustable nut being screw engaged with said center pin by screw thread provided on said center pin;
with this structure, said outer tube is displaced stably following the door movement, the door can be opened easily and closed rapidly without any noise by means of said two springs' two stage restoring force.

2. The door check hinge of claim 1, wherein a vertical hole is formed along the longitudinal direction through the body of said base tube outside of said pad block, a spring element having a set billet on its top end is contained in said vertical via hole, a spherical containment hole aimed at the corresponding position of said billet is formed on the bottom of tube body of said outer tube for permitting said set billet to enter so as to decide the stopping position of said outer tube and an open angle of the door.

3. The door check hinge of claim 2, wherein said vertical via hole is plural.

4. The door check hinge of claim 1, wherein said inner spring is longer than said outer spring.

5. the door check hinge of claim 1, wherein the inner restoring force of said inner spring provides a pausing force for the door, while the restoring force of said outer spring provides a force rapidly closing the door.

6. The door check hinge of claim 1, wherein said upper spacer block is formed of an inner tube and a pad block, wherein said inner spring is equipped in said inner tube, and said outer spring is enclosing over said inner tube.

7. The door check hinge if claim 1, wherein said fixing nut and said adjustable nut screw engaged with said center pin are for adjusting the elastic force of said inner and outer springs.
